(19) United States
(12) Patent Application Publication
(10) Pub. No.: US 2008/0084974 A1
(43) Pub. Date: Apr. 10, 2008

(54) METHOD AND SYSTEM FOR INTERACTIVELY SYNTHESIZING CALL CENTER RESPONSES USING MULTI-LANGUAGE TEXT-TO-SPEECH SYNTHESIZERS

(75) Inventor: Girish Dhanakshirur, Delray Beach, FL (US)

Correspondence Address: CANTOR COLBURN LLP - IBM BOCA RATON, 20 Church Street, 22nd Floor, Hartford, CT, 06103, US

(73) Assignee: International Business Machines Corporation, Armonk, NY (US)

(21) Appl. No.: 11/534,865

(22) Filed: Sep. 25, 2006

(51) Int. Cl. H04M 11/00

(52) U.S. Cl. 379/88.18

(57) ABSTRACT

A method and system for interactively synthesizing responses to a caller's queries includes using a text to speech synthesizer in a call center environment. A telephone network capable of receiving one or more telephone calls distributes calls to at least one or more call handlers. An interactive voice recognition platform having at least one database identifies an phone number associated with an incoming call and matches the phone number with the local language of the caller and provides this information in a signal to a media splitter. The call handler responds to the caller's queries by typing response information to the caller through a graphical unit interface at a workstation. A voice server receives the response information sends a signal to a text to speech synthesizer for conversion into speech. The produced speech from the text to speech synthesizer is sent back to the caller via the network and the caller is able to hear the answer to the caller's queries in the caller's local language.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates to telephone call centers and more particularly to interactively synthesizing responses using a multi-language text-to-speech (MLTTS) synthesizer.

2. Description of the Related Art

To handle customer care, telephone call centers are growing in large numbers in the United States and around the world. In effect, when conducting daily activities on the phone, one is frequently connected to a call center that is not located in the United States. However, while many of the call centers located in other countries have well spoken English educated personnel, many of the call center representatives have local accents. In short, for some personnel having English as their second language, there is a problem trying to communicate with callers from around the world.

Existing solutions for improving the performance of call center personnel includes spending large amounts of time and money on training. The process would involve training call center employees to speak various international languages with different accents based on the targeted regions. This solution hits its limit when a single call center is sourcing speakers of many different countries. There is also a limit in the ability of each employee to learn numerous languages or accents. Many of the existing call centers do not provide a system for screening incoming calls to improve service to the customer. Further, these call centers do little to accommodate language barriers beyond training of personnel. With the great number of languages, dialects and accents, this is inadequate.

What is needed is a technique for further reducing language barriers between callers and call center personnel. Preferably, the technique provides for efficient response to the caller's needs, while reducing cost to operators of the call center.

### SUMMARY OF THE INVENTION

As will be described below, important aspects of the invention reside in the method and system for interactively improving call center responses in a call center environment.

In accordance with one embodiment of the present invention a system for interactively synthesizing telephone call responses using a text to speech synthesizer in a call center environment is provided. The system includes a telephone network capable of receiving one or more telephone calls and distributing the calls to one or more call handlers. The telephone network distributes the call to an interactive voice recognition platform and after determining the caller's language, sends it to a media splitter. The media splitter outputs the signal to a telephone adapter and to a voice extensible markup language browser. Upon receiving the audio from the caller and distributed by the network, the call handler responds to the caller by inputting responses into a workstation with a graphical unit interface (GUI). A Voice Gateway which includes a VoiceXML or SALT browser, which is capable of synthesizing audio from text sends the text entered via the GUI to that speech synthesizer to process the text to speech. After the text is processed into speech, the speech is transmitted back to caller through a process similar to the incoming process to the network so that the caller can receive the response to the caller's inquires in the caller's natural language.

The invention is also directed towards a method for interactively synthesizing call center responses using multi-language text-to-speech synthesizers. The method includes connecting a call to an interactive voice response platform and determining the call origination language. The method then splits an output signal from the interactive voice response platform into a plurality of output signals and provides one of the output signals containing audio information as an input to a call handler node. The second output signal containing information associated with the caller's language is provided as an input into a Voice Extensible markup (VoiceXML) language browser or a Speech Application Language Tags (SALT) browser and then to a multi-language text-to-speech converter via a Voice Gateway. A text response from the call handler node in response to the audio information is then converted to an audio signal in accordance with the call origination language.

The shortcomings of the prior art are overcome and additional advantages are provided through the provision of a system that interactively synthesizes responses using a text-to-speech (MLTTS) synthesizer in a telephone call center environment. As a result of the summarized invention, one technically has achieved a solution that provides better customer caller service and satisfaction with reduced costs in the training of employees.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which tangibly embodies a program of instructions stored within a program storage device readable by a machine, and executable by the machine to perform a method for interactively synthesizing telephone call responses using a text-to-speech synthesizer in a call center environment is provided. The method includes connecting a call to an interactive voice response platform via a public switched telephone network and determining the call origination language. The method splits an output signal from the interactive voice response platform into output signals. One of the output signals contains audio information another contains information associated with the caller's language. The method provides a text response from the call handler node in response to the audio information and converts the text response to an audio signal in accordance with the call origination language.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram in accordance with the present invention for synthesizing responses using a MLTTS synthesizer in a call center system; and

FIG. 2 is a flowchart illustrating one method of the present invention shown in FIG. 1.

The detailed description explains the preferred embodiments of the invention together with advantages and features, by way of example with reference to the drawings.

### DETAILED DESCRIPTION OF THE INVENTION

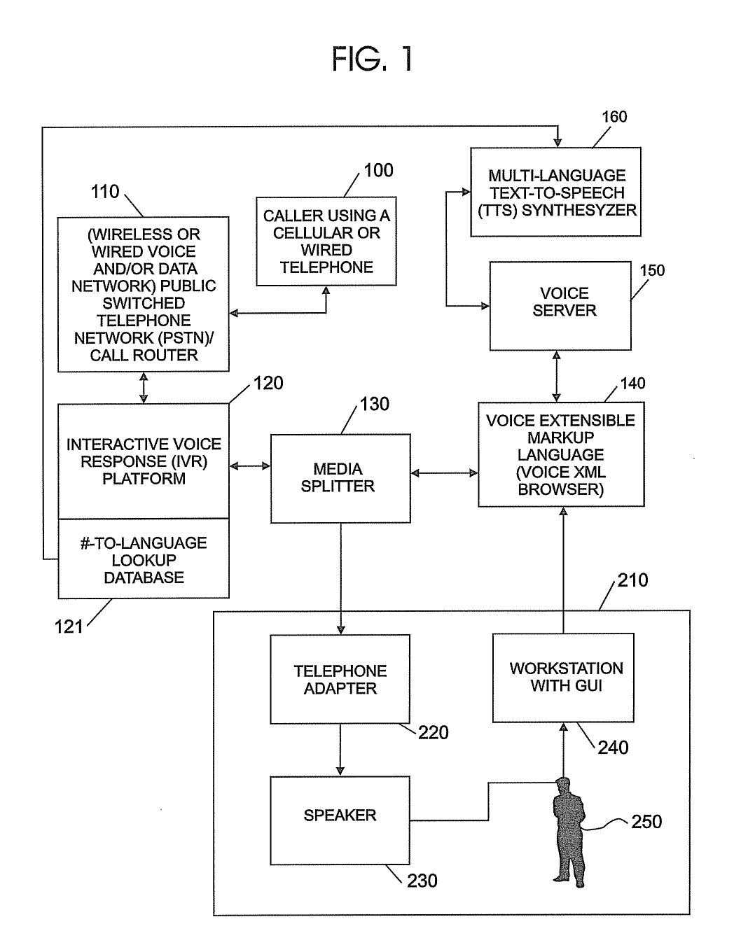

Turning now to the drawings in greater detail, it will be seen that in FIG. 1 there is a block diagram depicting aspects of a runtime system to interactively synthesize responses to a caller using a multi-language text-to-speech (MLTTS) synthesizer. In the exemplary embodiments, the MLTTS is used in a call center environment and provides outbound audio to a caller in at least one of the same language and dialect as that of the caller.

FIG. 1 shows an exemplary call center configuration. The configuration of FIG. 1 is illustrative rather than limiting of the teachings herein.

As shown in FIG. 1, a caller 100, using either a wireless phone or a wired phone, places a call to a call center whose purpose is usually to distribute the telephone calls to available customer service representatives, referred to herein as “call handlers.” The call center will distribute the incoming calls using any one of numerous well known automatic call distribution techniques to one node in the call center wherein the call is handled by a call handler in the call handler node 210. In this particular embodiment, the invention shows the distribution of the calls occurring via a public switch telephone network (PSTN) 110. This invention is not limited in this way, however, and applies as well as when other kinds of networks are employed, including voice-over-IP networks, cellular telephone networks, satellite networks, emergency networks, private corporation networks, and the like.

The PSTN 110 sends the input of the call into an Interactive Voice Response (IVR) platform 120. The IVR platform 120 includes a database 121 and is capable of accepting a combination of voice telephone input and touchtone keypad selection but is not limited to this combination. In one embodiment, the database 121 will include both area and world telephone codes of telephone numbers and the corresponding language associated with the area and world telephone codes. Information, including the caller's audio message, from the IVR platform 120 is sent to a media splitter 130. The media splitter 130 is also capable of sending information back to the IVR platform 120 and then in turn to the caller 100 through the PSTN 110. The media splitter 130 receives inbound calls from the PSTN 110 and sets up a connection with the inbound audio channel that has a telephone adapter 220 connected to a speaker 230 or headset so that the call handler can listen to the caller 100. The media splitter 130 also routes the information to the call handler and simultaneously opens a Voice Extensible Markup Language (XML) browser 140 session. The Voice XML 140 receives its information from a workstation and graphical user interface (GUI) 240. When the call handler receives a call, the call handler listens to the caller's 100 audio signal and replies to the caller 100 by typing the response to the caller 100 into a workstation with a graphical user interface (GUI) 240. The output from the GUI 240 is used as input into the Voice XML browser 140.

The Voice XML browser 140 receives information from the workstation with the GUI 240, whereby the call handler, after listening to the incoming audio on a speaker 230, responds to the caller 100 by entering a response message through the GUI at the workstation 240. The Voice XML browser 140 sends and receives signals and information to a voice server 150. The voice server 150 upon receiving the response message sends the response message to a text to speech (MLTTS) synthesizer 160. The text to speech synthesizer 160 processes the response message in accordance with information received from the IVR platform 120 and database 121 and sends audio signals back to the caller 100 by routing the information through the media splitter 130 to the IVR platform 120 through the telephone network 110 to the caller 100. In other words, the MLTTS synthesizer 160 synthesizes the outgoing audio so that the output is in the native language and accent of the caller 100 so that the outgoing voice sounds familiar to the caller 100. The preferred method uses a very high quality synthesizer 160, such as IBM Web Sphere Voice™ server, to synthesize responses to the caller's queries.

In an alternate embodiment, the database 121 sends the desired language response information directly to the MLTTS synthesizer 160. With the above setup in place, a call handler 250 is able to interactively respond to a caller 100 via a speech synthesizer 160. The IVR platform 120 is capable of providing the speech synthesizer 160 the information to select the correct language based on the incoming phone number and a corresponding database 121. After initializing the appropriate MLTTS synthesizer 160 based on the incoming call (for example, a synthesizer for one of the United States, the United Kingdom, or other language) responses are provided to the caller 100 in the caller's language.

One example of the incoming phone number being mapped to a language could be as follows: 1 800 XXX XXX2—can be mapped to United States English whereas 1 800 XXX XXX3—can be mapped to United Kingdom English.

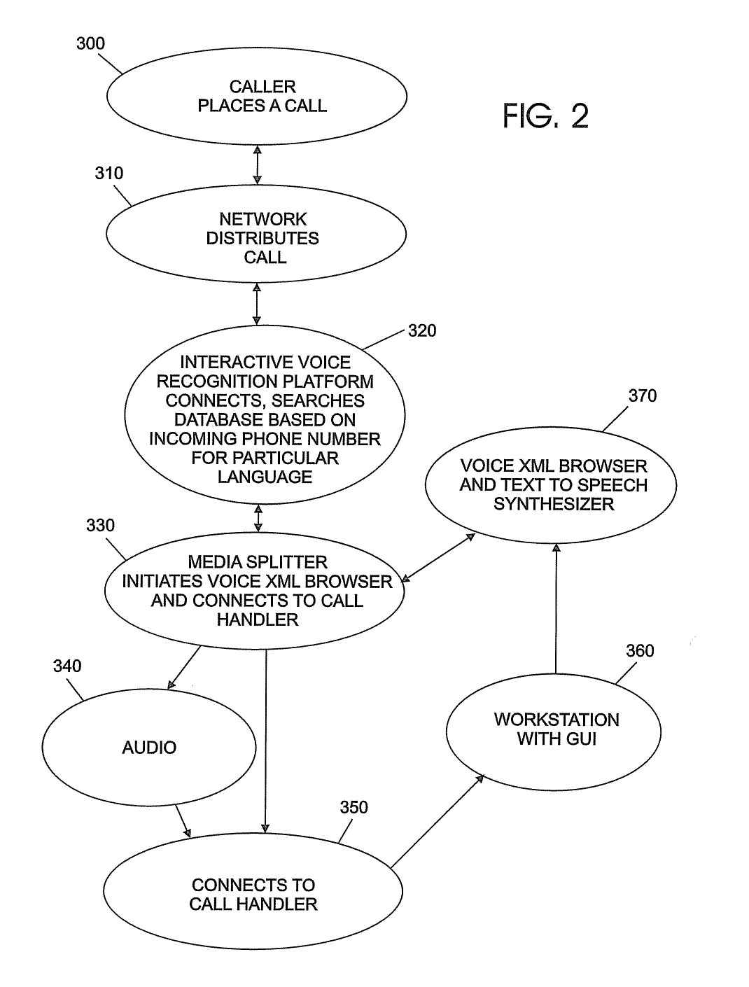

Referring to FIG. 2, there is shown a flow diagram of one embodiment in accordance with FIG. 1. One scenario is as follows. A caller places a call 300. The network receives the call and distributes 310 the call to the IVR platform. The platform then determines and assigns a language based on the incoming caller's telephone number after looking up and matching the information in a database 320. The IVR 120 sends the information and signal to the media splitter 130 so that the splitter can simultaneously initialize a Voice XML Browser 370 and rings a free call handler's extension 350 and assigns 340 the inbound audio to that extension. At this point, the call handler will see 360 a screen pop-up at a workstation and GUI that is connected to the above allocated browser ready for a chat session. The call handler 250 can hear what the caller on the phone is saying. The interaction between the caller and the call handler 250 can be broken down into the following example: Caller: What is my account balance? The audio flows from IVR 320 platform to the telephone adapter to the speaker 230. The call handler 250 responds by typing in the response “250 dollars.” This text is sent as a prompt for the waiting Voice XML browser 140 <prompt> 250 dollars </prompt>. The browser sends the prompt to a Voice Gateway such as IBM Voice Server 150 which in turn sends it to synthesizer 160 to synthesize audio. The audio is streamed back and sent as outbound audio to the IVR platform 120. The IVR platform 120 then sends the synthesized audio via the network 110 to the caller 100. The conversation continues in this context.

Accordingly, the teachings herein provide for using a runtime text to speech (referred to as the MLTTS) synthesizer and providing responses to the caller with the outbound audio having a language accent similar to the caller's accent.

It will be appreciated that a method and system for interactively synthesizing a response by using a MLTTS synthesizer in a call center environment is time efficient and reduces both time and cost of training employees in several different languages while providing better quality, satisfaction and service to customers.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for interactively synthesizing call center responses using multi-language text-to-speech synthesizers, the system comprising:
an interactive voice response platform, wherein the interactive voice response platform comprises;
a number-to-language lookup database; and
at least one multi language test-to-speech synthesizer connectable to the interactive voice response platform.

2. The system as in claim 1, further comprising a media splitter connectable to the interactive voice response platform.

3. The system as in claim 2, further comprising a voice extensible markup language browser connectable to the media splitter.

4. The system as in claim 3, further comprising a voice server connectable to the voice extensible markup language browser connectable to the media splitter.

5. The system as in claim 4, wherein the voice server is a Web Sphere voice server.

6. The system as in claim 4, farther comprising at least one multi-language text-to-speech synthesizer connectable to the voice server.

7. The system as in claim 1, further comprising a call handler node, wherein the call handler node comprises:
a telephone adapter;
a speaker connectable to the telephone adapter; and
a workstation for inputting call responses derived from the speaker.

8. A method for interactively synthesizing call center responses using multi-language text-to-speech synthesizers, the method comprising;
connecting a call to an interactive voice response platform
determining the call origination language;
splitting an output signal from the interactive voice response platform into a plurality of output signals, wherein splitting the output signal from the interactive voice response platform further comprises:
providing a first one of the plurality of output signals as an input to a call handler node, wherein the first one of the plurality of output signals contains audio information; and
providing a second one of the plurality of output signals as an input into a voice extensible markup language browser, wherein the second one of the plurality of output signals contains information associated with the caller's language;
providing a text response from the call handler node in response to the audio information; and
converting the text response to an audio signal in accordance with the call origination language.

9. The method as in claim 8 wherein connecting the call to the interactive voice response platform telephone network further comprises connecting the call via a public switched telephone network.

10. The method as in claim 8, wherein determining the call origination language further comprises indexing a caller identification phone number to language database

11. The method as in claim 8, wherein providing the first one of the plurality of output signals as an input to the call handler node further comprises adapting the first one of the plurality of output signals to an audio output.

12. The method as in claim 8, wherein converting the text response to audio speech in accordance with the call origination language further comprises providing a voice server for rendering an audio response of the audio signal.

13. The method as in claim 12, wherein providing the voice server for rendering the audio response of the audio signal further comprises providing a Websphere voice server.

14. The method as in claim 13, wherein providing the text response from the call handler node in response to the audio information further comprises providing the text response from the call handler node to the voice extensible markup language browser.

15. The method as in claim 13, further comprising providing the text response from the voice extensible markup language browser to the voice server.

16. A program storage device readable by a machine, tangibly embodying a program of instructions executable by the machine to perform a method for interactively synthesizing call center responses using multi-language text-to-speech synthesizers, the method comprising;
connecting a call to an interactive voice response platform, wherein connecting the call to the interactive voice response platform telephone network further comprises connecting the call via a public switched telephone network;
determining the call origination language, wherein determining the call origination language further comprises indexing a caller identification phone number to language database;
splitting an output signal from the interactive voice response platform into a plurality of output signals, wherein splitting the output signal from the interactive voice response platform further comprises:
providing a first one of the plurality of output signals as an input to a call handler node, wherein the first one of the plurality of output signals contains audio information and wherein providing the first one of the plurality of output signals as an input to the call handler node further comprises adapting the first one of the plurality of output signals to an audio output;
providing a second one of the plurality of output signals as an input into a voice extensible markup language browser, wherein the second one of the plurality of output signals contains information associated with the caller's language;
providing a text response from the call handler node in response to the audio information; and
converting the text response to an audio signal in accordance with the call origination language, wherein converting the text response to audio speech in accordance with the call origination language further comprises providing a voice server for rendering an audio response of the audio signal.
